(19) United States
(12) Patent Application Publication
(10) Pub. No.: US 2009/0062156 A1
(43) Pub. Date: Mar. 5, 2009

(54) Methods of treating a subterranean formation including a biocidal treatment

(75) Inventors: J. Michael Wilson, Duncan, OK (US); Jimmie D. Weaver, Duncan, OK (US); Billy F. Slabaugh, Duncan, OK (US)

Correspondence Address: ROBERT A. KENT, P.O. BOX 1431, DUNCAN, OK, 73536, US

(73) Assignee: Halliburton Energy Services, Inc.

(21) Appl. No.: 11/897,595

(22) Filed: Aug. 31, 2007

(51) Int. Cl. C09K 8/90

(52) U.S. Cl. 507/211

(57) ABSTRACT

A method of treating a subterranean formation including with a bactericidal fluid is provided. The method comprises the steps of: (a) continuously mixing to obtain a stream of a treatment fluid: (i) a base fluid comprising water; (ii) an aqueous solution comprising a hypochlorite having a pH equal to or greater than 7; and (iii) a pH-adjusting agent selected to be capable of lowering the pH of water to less than 7; and (b) injecting the treatment fluid into a wellbore. The step of continuously mixing the base fluid, the aqueous solution of hypochlorite, and the pH-adjusting agent is preferably under conditions and in proportions sufficient to obtain a stream of a treatment fluid having a free chlorine concentration of at least 1 ppm by weight of the water in the treatment fluid and having a pH in the range of 4-7.

### CROSS-REFERENCE TO RELATED APPLICATIONS

Not applicable

### STATEMENT REGARDING FEDERALLY SPONSORED RESEARCH OR DEVELOPMENT

Not Applicable.

### REFERENCE TO A MICROFICHE APPENDIX

Not applicable.

### TECHNICAL FIELD

The present invention generally relates to methods for the treatment of at least a portion of a subterranean formation, including with a bactericidal fluid.

### BACKGROUND

Bacteria and their metabolites are the root of many problems in any water system. In water systems, bacteria exist as members of a “biofilm,” a meta-community consisting of microbial cells (algal, fungal or bacterial) and the extracellular biopolymers the cells produce. Together, these constitute a bioburden for a given water system. Biofilms for the most part may be invisible to the naked eye, such as in a flowing stream. However, in extreme cases of biofilm formation, the biofilm may be a bulky, slimy mass which is visible.

For the oilfield, problems associated with biofilms and bacterial growth are bio-fouling and plugging, corrosion of tanks and piping, and destruction of chemicals used to produce oil and gas. Bacteria may also be responsible for souring production by producing hydrogen sulfide; this also leads to corrosion and potential plugging by precipitating iron sulfide (FeS).

The most common system of classification for bacteria is by their need for oxygen, i.e., aerobic or anaerobic. (This not strictly true; there are facultative bacteria which can thrive under aerobic or anaerobic conditions.) Aerobic bacteria require oxygen to thrive. Anaerobic bacteria cannot tolerate oxygen. However, even in an aerated system, anaerobic bacteria can thrive if they are shielded from the oxygen. The usual shielding materials are sediments, scale or corrosion deposits, and bacterial slimes.

Bacteria exist in two states, “planktonic” and “sessile.” Planktonic are free floating, whereas sessile are attached to a surface. When water is sampled for assessment and suitability for service work, only the planktonic bacterial population is in the sample. Hence, we are probably sampling a small part of the bacterial population of the water system. This does not mean that these bacteria will not become sessile. Bacteria are very adaptive; they can survive in fresh or salty water (up to saturation). They can tolerate a wide temperature range and will adapt to new conditions as required to survive.

From an oil-field service company point of view, there are two bacterial concerns. The first of these is the impact bacteria may have on the service chemicals to be used in a treatment. The second concern is the impact the presence of bacteria will have on the well bore or formation to be treated.

The most common bacteria encountered in oilfield waters are the slime formers. Some are aerobic and some are anaerobic. The greatest concern here is that the presence of aerobic slime formers may have adverse effects on chemicals used to prepare our treating fluids, such as, gelling agents used to prepare gelled fracturing fluids. There have even been reports that, particularly in the hot summertime, bacterial action is so rapid that suitable base gels cannot be formed. More likely, less aggressive bacterial actions may cause a rapid decline in base fluid viscosity after gelling up. In such cases, some sort of treatment needs to be applied to these waters ahead of time to mitigate these adverse effects on the service chemicals used in the treatment fluids.

Some of the more serious and longer term problems associated with bacteria come in the form of sulfate reducing bacteria (“SRB”). These are anaerobic bacteria which reduce the sulfate ion to sulfide. While these particular bacteria are not a problem to common oil-field service chemicals, the introduction of SRB may lead to contamination of the producing formation and the wellbore with SRB. The sulfide produced by SRB can lead to the corrosion of iron or steel. Corrosion of production piping and storage tanks is a major problem created by SRB contamination. Severe iron sulfide scaling may also choke production, either in the production piping, perforations or within the producing formation itself. SRB are also slime formers, which add to the biomass further exacerbating production problems. SRB may lead to the formation of hydrogen sulfide (H₂S), which can pose a possible health hazard and can lead to sour gas or oil production.

SRB are particularly and maybe even primarily responsible for sour production in fields under waterflood, where a continuous supply of sulfate ion (food) is being continuously added to the formation being flooded. They are sessile by nature and therefore are likely to be attached in the rock or piping. They are also likely to be found growing under a blanket of film or slime which further protects them for the adverse effect of dissolved oxygen. In a sense, they may exist in a symbiotic relationship with other bacteria.

They can exist in both fresh water and brines. The sessile colonies are most often found in areas with stagnant or slow moving water, such as stagnant points in flowlines or pipelines, beneath deposits or slimes in vessels (tanks) or pipes. They can be found in the rat holes of producing or injection wells, or in drilling mud left behind casing. There are a number ways they can be introduced into a well by the various treating fluids used to construct the well. And there has been some conjecture whether they were originally laid down in sedimentary rock and were at equilibrium with their environment until the well was drilled.

SRB exist in all natural bodies of water, including seawater. They are most commonly associated with the bottom sediments or attached to the rock surfaces of the natural stream or lake bed. While the majority of this population is sessile, invariably there are a few planktonic “floaters.” Therefore, sourcing water from natural bodies is a likely source for SRB contamination. Sampling of the water near the bottom or near the side will include higher populations of SRBs.

Thus, the presence of anaerobic bacteria in an oil and/or gas producing formation, and particularly sulfate reducing bacteria, cause a variety of problems. If the bacteria produce sludge or slime, they can cause a reduction in the porosity of the formation which, in turn, reduces the production of oil and/or gas therefrom. Sulfate reducing bacteria produce hydrogen sulfide, and the problems associated with hydrogen sulfide production, even in small quantities, are well known. The presence of hydrogen sulfide in produced oil and gas can cause excessive corrosion in metal tubular goods and surface equipment, a lower oil selling price, and the necessity to remove hydrogen sulfide from gas prior to sale.

U.S. Pat. No. 5,016,714, having for named inventors Michael A. McCabe; J. Michael Wilson; Jimmie D. Weaver; and James J. Venditto issued on May 21, 1991, discloses in the abstract thereof methods of treating a previously fractured bacteria contaminated subterranean formation penetrated by a well bore whereby the bacteria contamination is substantially reduced or eliminated are provided. The methods basically comprise mixing a bactericide with a fracturing fluid in an amount effective to contact and kill bacteria contained in the formation and pumping the mixture into the formation at a rate and pressure sufficient to re-fracture the formation. The re-fracturing of the formation causes the bactericide to be distributed throughout the formation and to contact and kill bacteria contained therein without adversely effecting the productivity of the formation. U.S. Pat. No. 5,016,714 is incorporated herein by reference in its entirety.

By the present invention, improved methods of treating subterranean formations are provided including a bactericidal treatment, whereby bacteria are prevented from entering the formation or existing bacteria are substantially reduced or eliminated.

### SUMMARY OF THE INVENTION

According to one aspect of the invention, a method of treating a subterranean formation including with a bactericidal fluid is provided. The method comprises the steps of: (a) continuously mixing as a stream to obtain a stream of a treatment fluid: (i) a base fluid comprising water; (ii) an aqueous solution comprising a hypochlorite having a pH equal to or greater than 7; and (iii) a pH-adjusting agent selected to be capable of lowering the pH of water to less than 7; and (b) injecting the treatment fluid into a wellbore.

These and further aspects of the invention are described in more detail below.

### BRIEF DESCRIPTION OF THE DRAWING

A more complete understanding of the present disclosure and advantages thereof may be acquired by referring to the following description taken in conjunction with the accompanying drawings, in which:

FIG. 1 is a graph showing the effect of pH on hypochlorous acid content in an aqueous solution at about room temperature, where the percent undissociated hypochlorous acid is shown approaching or at 100% in a pH range of about 4-6, wherein the percent hypochlorite ion increases in a pH range of about 6-10 from 0% to 100%, wherein the percent hypochlorite ion is shown at 100% in a pH range of about 10-14, and wherein in highly acidic pH ranges below about 4, the hypochlorous acid begins to form Cl₂.

### DETAILED DESCRIPTION

As used herein, the words “comprise,” “has,” and “include” and all grammatical variations thereof are each intended to have an open, non-limiting meaning that does not exclude additional elements or parts of an assembly, subassembly, or structural element.

As used herein, the term “stream” means a flow of fluid moving continuously.

As used herein, the terms “upstream” and “downstream” means with respect to the movement of a stream through a method according to the invention.

As used herein, the term “water soluble” means at least 0.1 mol/L in distilled water when tested at standard temperature and pressure (“STP”).

A “bactericide” (also sometimes known as a “bacteriocide”) is a substance that inhibits or kills bacteria. Bactericides are typically classified as disinfectants, antiseptics, or antibiotics.

A disinfectant is an antimicrobial agent that can be applied to non-living objects to destroy microorganisms, the process of which is known as disinfection. Disinfectants are generally distinguished from antibiotics that destroy microorganisms within the body, and from antiseptics that destroy microorganisms on living tissue.

A sanitizer is a high-concentration disinfectant that kills over 99.9% of a target microorganism in applicable situations. Very few disinfectants and sanitizers can sterilize (i.e., completely eliminate all microorganisms), and those that can depend entirely on their mode of application.

Bacterial endospores are most resistant to disinfectants; however, some viruses and bacteria also possess some tolerance.

If there is any conflict in the usages of a word or term in this specification and one or more patent or other documents that may be incorporated herein by reference, the definitions that are consistent with this specification should be adopted for the purposes of understanding this invention.

Chlorine is a disinfectant that kills pathogens such as bacteria by breaking the chemical bonds in the molecules of the bacteria. Chlorine can exchange atoms with other compounds, such as enzymes in bacteria. When enzymes come in contact with chlorine, one or more of the hydrogen atoms in the molecule are replaced by chlorine. This causes the entire molecule to change shape or fall apart. When the enzymes of a bacterium do not function properly, the bacterium will die.

The cell wall of bacteria is naturally negatively charged. Thus, it can be penetrated by neutrally-charged hypochlorous acid, but less readily by the negatively-charged hypochlorite ion. Hypochlorous acid can penetrate slime layers, cell walls, and protective layers of bacteria and effectively kills the bacteria.

Chlorine can be added to water as chlorine gas (Cl₂), a hypochlorite, such as sodium hypochlorite (NaOCl), or chlorine dioxide (ClO₂).

When chlorine gas is added to water, hypochlorous acid is formed:

Cl₂+H₂O→HOCl+H⁺+Cl⁻ (Eq. 1)

Depending on the pH of the aqueous solution, hypochlorous acid can dissociate to hypochlorite ions:

Cl₂+2H₂O→HOCl+H₃O⁺+Cl⁻ (Eq. 2)

HOCl+H₂O→H₃O⁺+OCl⁻ (Eq. 3)

Hypochlorite can dissociate to chlorine and oxygen atoms:

OCl⁻→Cl⁻+O (Eq. 4)

The disinfecting properties of chlorine in water are based on the oxidizing power of the free oxygen atoms and on chlorine substitution reactions.

Hypochlorous acid is more reactive and is a much stronger disinfectant than hypochlorite. Hypochlorous acid can split into hydrochloric acid (HCl) and atomic oxygen (O). The oxygen atom is a powerful disinfectant. For disinfecting water, hypochlorous acid is not only more reactive than the hypochlorite ion (OCl⁻), but is also a stronger disinfectant and oxidizer of pathogens. Depending on the particular report, hypochlorous acid is reported to be 30 to 100 times more effective as a bactericide than hypochlorite ion. Thus, it is observed that even a small increase in the relative concentration of hypochlorous acid can have a dramatic increase in the effectiveness of a chlorine solution as a bactericide. The hypochlorous acid has a fast rate of bactericidal action, which is important in treating methods of treating subterranean formations with large volumes of treatment fluid mixed on the fly and injected into a wellbore at a high rate.

When chlorine is added to water for disinfection purposes, it can initially react with dissolved organic and inorganic compounds in the water that may be susceptible to reaction with chlorine. Chlorine reacts with organic matter reactive to chlorine to disinfection byproducts, such as trihalomethanes (THM) and halogenated acetic acids (HAA). To the extent the added chlorine reacts with such compounds, it is no longer available for disinfection purposes because it has formed other reactive products. The amount of chlorine that is used up by reaction with such compounds is referred to as the “chlorine enquiry” of the water. The chlorine enquiry is related to the bioburden of the water.

Chlorine can react with ammonia (NH₃) to chloramines, chemical compounds which contain chlorine, nitrogen (N) and hydrogen (H). These compounds are referred to as “active chlorine compounds” (contrary to hypochlorous acid and hypochlorite, which are referred to as “free active chlorine”) and can be effective for water disinfection. However, these compounds react much more slowly than free active chlorine.

When dosing chlorine, the fact that chlorine reacts with certain types of other compounds that are present in the water should be taken into account. The dose has to be high enough for a significant amount of chlorine to remain in the water for disinfection. Chlorine enquiry is determined by the amount of organic matter reactive to chlorine in the water, the pH of the water, contact time, and temperature.

In water disinfection treatment, “breakpoint chlorination” consists of a continual addition of chlorine to the water up to the point where the chlorine enquiry is met and all present ammonia is oxidized, so that only free chlorine remains. This is usually applied for disinfection, but it also has other benefits, such as smell and taste control, if the application is for treating potable water. In order to reach the breakpoint, a superchlorination is applied, usually a chlorine concentration in excess of at least 1 mg/L (1 ppm) required for disinfection.

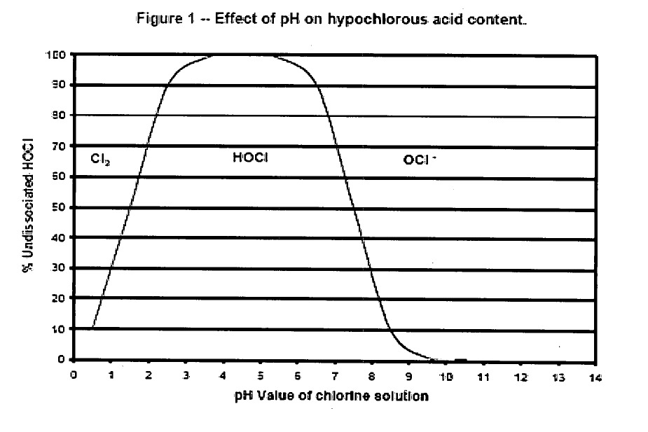

When a source of chlorine, such as chlorine gas (Cl2) or a hypochlorite is added to water, free chlorine forms a mixture of hypochlorous acid (HOCl) and hypochlorite ion (OCl⁻). The relative amount of each is dependant on the pH, as shown in FIG. 1. The total of HOCl and OCl⁻ is defined as “free chlorine.” To accurately measure free chlorine concentrations, the pH and temperature must be taken into account.

While chlorine gas (Cl₂) under standard conditions is a pale green gas about 2.5 times as dense as air. It has a disagreeable suffocating odor and is poisonous, so toxic, in fact, that it has been used as a poison gas in warfare. Although otherwise a cheap source of chlorine, and while the risks of transporting and using chlorine gas are manageable for many applications, it is believed it would be too dangerous for transportation, storage, and use under the rough conditions around an oil or gas well. Hypochlorite is a relatively safer source of chlorine. An example of a hypochlorite is sodium hypochlorite. The structural formula of sodium hypochlorite is NaOCl, having a molecular weight of 74.4 g/mole. Sodium hypochlorite is a liquid having a green to yellow color. It has a chlorine (bleach) odor. The odor is due to breakdown products such as chlorine.

Sodium hypochlorite is soluble in water in all proportions. The specific gravity of sodium hypochlorite is about 1.1 (6% aqueous solution) or 1.21 for a 14% aqueous solution.

The pH of a sodium hypochlorite solution is about 11.

The melting point of solid sodium hypochlorite is −6° C. (21° F.) (5% aqueous solution); and it rapidly decomposes above 40° C. (104° F.).

Sodium hypochlorite is usually sold in solutions containing 5% to 15% sodium hypochlorite in water, with 0.25% to 0.35% free alkali (usually NaOH) and 0.5% to 1.5% NaCl. Solutions of up to 40% sodium hypochlorite in water are commercially available.

Solid sodium hypochlorite (NaOCl0.5H₂O) can be obtained, but it is not usually used on a commercial scale.

Although sodium hypochlorite is much safer than chlorine gas or chlorine dioxide, it has some hazardous characteristics. A sodium hypochlorite solution decomposes slowly, even if stabilized with a base. Decomposition is speeded up by heat (temperatures above 40° C.) and light. The decomposition products include chlorine, oxygen, and sodium chlorate, which can be hazardous.

Sodium hypochlorite is chemically incompatible with certain other chemicals and materials. Nitrogen compounds (e.g., ammonia, urea, amines, isocyanurates) with sodium hypochlorite can form toxic, reactive chloramines. When hypochlorite is in excess to the nitrogen compounds, nitrogen gas is formed. Ammonium salts and sodium hypochlorite can form explosive nitrogen trichloride in the presence of acid. Acids (especially hydrochloric acid HCl) with sodium hypochlorite can cause the release of chlorine gas. Methanol and sodium hypochlorite can form methyl hypochlorite, which can explode. Some metals, especially copper, nickel and cobalt, speed up the decomposition of NaOCl. Hypochlorite solutions are corrosive to many metals, increasingly so at lower pH ranges. While chemical incompatibility is of concern, the actual degree of risk is highly dependent on the concentrations involved.

According to the invention, a method of treating a subterranean formation including with a bactericidal fluid is provided. The method comprises the steps of: (a) continuously mixing as a stream to obtain a treatment fluid: (i) a base fluid comprising water; (ii) an aqueous solution comprising a hypochlorite having a pH equal to or greater than 7; and (iii) a pH-adjusting agent selected to be capable of lowering the pH of water to less than 7; and (b) injecting the treatment fluid into a wellbore. Preferably, the step of continuously mixing further comprises mixing the base fluid, the aqueous solution of a hypochlorite, and the pH-adjusting agent under conditions and in proportions sufficient to obtain a treatment fluid having a free chlorine concentration of at least 1 ppm by weight of the water in the treatment fluid and having a pH in the range of 4-7.

The water of the base fluid that is typically used in a well treatment has a pH in the range of about 6.5-9. The water of the base fluid usually has a pH greater than 7, and often equal to or greater than 7.5. More particularly, the water of the base fluid typically has a pH in the range of 7.5-9. According to the invention, the pH of the water of the base fluid is recognized to be of this typical nature, and, therefore, this is one of the factors used in developing the criteria for the present invention and the advantages and benefits thereof.

The base fluid typically comprises a water source selected from the group consisting of: freshwater; produced water; flowback water; brackish water; seawater; brine; and any combination thereof in any proportion.

The water of the base fluid would normally be expected to have no significant concentration of free chlorine. More particularly, the base fluid would normally be expected to have less than 1 ppm free chlorine by weight of the water of the base fluid.

The density of the base fluid can be adjusted depending on the particular purpose or stage of the well treatment. For example, the base fluid can further comprise a weighting agent, such as an inorganic salt, to increase the density of the treatment fluid. The present invention also contemplates that the base fluid or treatment fluid can be foamed according to techniques well known in the oil and gas industry.

The base fluid or the treatment fluid can have different viscosity and fluid-loss characteristics depending on the particular purpose or stage of the treatment. For example, the base fluid or the treatment fluid can have a low viscosity of less than 10 cp and high fluid-loss characteristics for ease of penetration into a formation.

The base fluid or the treatment fluid can have a viscosity-increasing agent for assisting in suspending a proppant for a gravel packing or fracturing treatment of the well. The viscosity-increasing agent can be, for example, a hydratable polymer or a viscoelastic surfactant. In a well treatment employing a viscosity-increasing agent, the viscosity-increasing agent is preferably present in the treatment fluid in an amount in the range of from about 10 lbs. to about 80 lbs. per 1000 gallons of the water in the treatment fluid. In a well treatment fluid with a proppant material, the proppant material is preferably present in said fracturing fluid in amounts ranging from about 0.25 lb. to about 25 lbs. per gallon of the treatment fluid.

The base fluid or the treatment fluid can also have a friction-reducing agent, which is sometimes also referred to in the art as a drag reducing agent. Typical examples of a friction-reducing agent include: polyacrylamide and co-polymers of polyacrylamide and acrylic acid.

It should be understood that a viscosity-increasing agent or a proppant material can be mixed with the base fluid upstream, downstream, or simultaneously with the step of mixing the base fluid, the aqueous solution of a hypochlorite, and the pH-adjusting agent, in any convenient and practical sequence.

The aqueous solution of a hypochlorite can be made up, for example, with hypochlorite selected from the group consisting of: sodium hypochlorite, lithium hypochlorite, calcium hypochlorite, and any combination thereof in any proportion. The aqueous solution of a hypochlorite preferably comprises an alkali metal hypochlorite. For example, the solution may have been made up with an alkali metal hypochlorite, most preferably sodium hypochlorite.

The aqueous solution of a hypochlorite is preferably pH stabilized with an alkali metal hydroxide. For example, the alkali metal hydroxide can be selected from the group consisting of sodium hydroxide, lithium hydroxide, or any combination thereof in any proportion.

The aqueous solution of a hypochlorite most preferably has a pH in the range of 10-14.

Most preferably, the aqueous solution of a hypochlorite comprises hypochlorite in a concentration of at least 5% by weight of the water of the aqueous solution. The aqueous solution comprises hypochlorite in a concentration in the range of 5%-40% by weight of the water of the aqueous solution.

The aqueous solution of a hypochlorite prior to the step of mixing with the base fluid and the pH-adjusting agent most preferably has a concentration of at least 50,000 ppm free chlorine by weight of the water of the aqueous solution.

According to a presently preferred embodiment, the step of mixing further comprises mixing the aqueous solution of a hypochlorite in the range of 0.01% to 1% by weight of the water in the base fluid.

According to another presently preferred embodiment, the step of mixing is further under conditions sufficient to obtain a stream of a treatment fluid having a free chlorine concentration of at least 10 ppm. More preferably, the step of mixing is further under conditions sufficient to obtain a stream of a treatment fluid having a free chlorine concentration in the range of 10-1,000 ppm. Most preferably, the step of mixing is further under conditions sufficient to obtain a stream of a treatment fluid having a free chlorine concentration in the range of 100-1,000 ppm.

According to another presently preferred embodiment of the invention, the step of mixing is further under conditions sufficient to obtain a stream of a treatment fluid having a free chlorine concentration effective to kill bacteria on contact.

Preferably, after the step of injecting, the wellbore is preferably shut-in for a time period of from about 1 hour to about 2 weeks in order to allow the bactericide to leak off flow through the pores of the formation into contact with bacteria contained therein.

According to a presently preferred embodiment, the pH-adjusting agent is in an aqueous solution prior to the step of continuously mixing. This facilitates the step of mixing.

The pH-adjusting agent can be selected from the group consisting of: an acid, a buffering agent, and any combination thereof in any proportion. Although strong inorganic acids can be used, they tend to be more hazardous to use because in excess a strong inorganic acid may drive the pH below 4, causing the release of chlorine gas (Cl₂). Preferably, the pH-adjusting agent comprises a water-soluble organic acid, for example, selected from the group consisting of acetic acid, citric acid, fumaric acid, sulfamic acid, formic acid, hydroxyacetic acid, glycolic acid, and any combination thereof in any proportion.

The pH-adjusting agent can be a delayed-release acid, whereby the pH of the treatment fluid is reduced in-situ after being injected through the wellbore. Examples of delayed-release acid can be selected from the group consisting of: an ortho ester, poly(ortho ester); aliphatic polyester; lactide; poly(lactide); glycolide; poly(glycolide); lactone; poly(.epsilon.-caprolactone); poly(hydroxybutyrate); anhydride; poly(anhydride); or a poly(amino acid); an esterase enzyme, and any combination thereof in any proportion. More preferably, the delayed-release acid comprises a poly(lactic acid) and an ortho ester.

Except for the purpose of adjusting the pH of the treatment fluid to the desired pH range, the pH-adjusting agent should not be used in any concentration incompatible with hypochlorite. For example, while hydrochloric acid can be used to adjust the pH to a desired range, a concentration that would reduce the pH below 4 and risk generating substantial amounts of chlorine gas at the surface near the wellbore should be avoided.

According to the invention, it is recognized that lowering the pH from a basic pH toward or to an acidic pH range can substantially increase the concentration of hypochlorous acid in solution. According to one aspect of the invention, it is recognized that appreciable benefits can be obtained by adjusting the pH such that the stream of the treatment fluid has a pH that is at least 1 pH unit lower than the pH of the water of the base fluid.

According to another aspect of the invention, the stream of the treatment fluid has a pH in the range of 5-7. This pH range provides a relative concentration of 100%-75% hypochlorous acid, and provides a greater margin of safety at the lower end of this pH range against prematurely or undesirably generating Cl₂. More preferably, the stream of the treatment fluid is pH adjusted to have a pH in the range of 5-6.5. This pH range provides a relative concentration of 100%-90% hypochlorous acid, which, considering the greater effectiveness of hypochlorous acid relative to hypochlorite, provides at least about 90% hypochlorous acid. Most preferably, the treatment fluid has a pH in the range of 6-6.5. This pH range provides a relative concentration of 97%-90% hypochlorous acid of the free chlorine, but the pH is not so low as to unduly increase the corrosiveness of the treatment fluid. A treatment fluid of free chlorine becomes increasingly corrosive as the pH is lowered, and more dramatically so as the pH is lowered below about 6.

The step of continuously mixing as a stream, sometimes known as “dynamic mixing,” provides a thorough mixing of the fluids with an impeller pump. Such pumps are well known in the art. According to this step, a base fluid is conducted to an impeller pump through a main pipe. A plurality of injection ports is located in the pipe, typically within about one foot from a body of the pump. The injection ports can be connected to metering pumps to selectively add various additives to the base fluid, such as an aqueous solution of a hypochlorite, an aqueous solution of a pH-adjusting compound, and an aqueous solution of a surfactant conditioning agent. The main pipe delivers the base fluid and the one or more additives to the eye of the centrifugal of the pump. A discharge pipe delivers the thoroughly-mixed stream of treatment fluid where desired.

If desired, the treatment fluid can simultaneously be mixed with other materials, such as any one or more materials selected from the group consisting of: a viscosity-increasing agent, a cross-linking agent, a gravel or proppant, a breaker, and a surfactant, and any combination thereof in any proportion.

Continuously mixing as a stream is particularly advantageous because it provides much more thorough mixing than batch mixing or stirring in a tank. In a batch mixing process, there may be portions of the tank or pit that are not adequately mixed. For the purpose of a bactericide, if the concentration of the bactericide is not sufficiently high throughout the mixture, bacteria may survive and rapidly reproduce to re-contaminate all the fluid in the tank or pit.

According to one aspect of the invention, the stream of treatment fluid is deposited into one or more water storage tanks or pits prior to the step of injecting the treatment fluid into a wellbore. The storage period prior to use of the treatment fluid can be any convenient time period, which would be expected to typically range anywhere, for example, from a few minutes to several weeks. The treatment fluid from the storage tanks or pits can be subsequently injected into a wellbore. The treatment fluid can be used as is or, if desired, mixed with other materials, such as any one or more materials selected from the group consisting of: a viscosity-increasing agent, a cross-linking agent, a gravel or proppant, a breaker, and a surfactant, and any combination thereof in any proportion.

According to another aspect of the invention, the step of injecting the treatment fluid is without holding the treatment fluid in a fluid reservoir between the step of continuously mixing and the step of injecting. Such a mixing technique is known in the art as mixing “on the fly.”

The step of continuously mixing can comprise co-injecting any one or two of the base fluid, the aqueous solution comprising free chlorine, and the pH-adjusting agent with the other one or two of the base fluid, the aqueous solution of free chlorine, and the pH-adjusting agent.

The step of continuously mixing can comprise continuously mixing the base fluid, the aqueous solution of a hypochlorite, and the pH-adjusting agent in any sequence, upstream, downstream, or simultaneously relative to each other.

The step of continuously mixing can be co-injecting during the step of injecting.

The step of injecting the treatment fluid is preferably at a rate in the range of 5-160 barrels per minute.

The step of injecting can be pumping the treatment fluid through the wellbore and into the subterranean formation at a rate and pressure sufficient to fracture the formation. This will thereby cause the solution of free chorine to be distributed into the formation and to contact and kill at least a portion of any bacteria in the formation.

The step of injecting the treatment fluid through the wellbore into the formation is so that bacteria in near-wellbore portions of the formation are contacted with the treatment fluid.

The step of continuously mixing as a stream further can include mixing to obtain a treatment fluid including a material susceptible to bacterial attack.

The step of continuously mixing as a stream can include mixing with a material selected from the group consisting of: a polysaccharide, a sugar-headed surfactant, a friction-reducing agent, a polyvinyl alcohol, and any combination thereof in any proportion.

The method according to the invention further comprising any step selected from the group consisting of: drilling, completion, fracturing, clean up.

The method preferably further includes, after the step of injecting, shutting in the wellbore for a time period of from about 1 hour to about 2 weeks in order to allow the bactericide to leak off flow through the pores of the formation into contact with bacteria contained therein.

According to a presently preferred embodiment of the invention, a method of treating a subterranean formation comprising is provided including the steps of: (a) continuously mixing as a stream: (i) a base fluid comprising water having a pH equal to or greater than 7.5, and wherein the base fluid has less than 1 ppm free chlorine by weight of the water of the base fluid; (ii) an aqueous solution comprising a hypochlorite having a pH equal to or greater than 10; and (iii) a pH-adjusting agent selected to be capable of lowering the pH of water to less than 7; wherein the step of continuously mixing is under conditions and in proportions sufficient to obtain a stream of a stream of a treatment fluid having a free chlorine concentration of at least 1 ppm by weight of the water in the treatment fluid and having a pH in the range of 5-6.5; and (b) injecting the treatment fluid into a wellbore.

Thus, the present invention is well adapted to carry out the objects and attain the ends and advantages mentioned above as well as those inherent therein. While preferred embodiments of the invention have been described for the purpose of this disclosure, changes in the construction and arrangement of parts and the performance of steps can be made by those skilled in the art, which changes are encompassed within the spirit of this invention as defined by the appended claims.

What is claimed is:

1. A method of treating a subterranean formation comprising the steps of:
(a) continuously mixing as a stream to obtain a stream of a treatment fluid:
(i) a base fluid comprising water;
(ii) an aqueous solution comprising a hypochlorite having a pH equal to or greater than 7; and
(iii) a pH-adjusting agent selected to be capable of lowering the pH of water to less than 7; and
(b) injecting the treatment fluid into a wellbore.

2. The method according to claim 1, wherein the step of continuously mixing further comprises continuously mixing the base fluid, the aqueous solution comprising a hypochlorite, and the pH-adjusting agent under conditions and in proportions sufficient to obtain a stream of a treatment fluid having a free chlorine concentration of at least 1 ppm by weight of the water in the treatment fluid and having a pH in the range of 4-7.

3. The method according to claim 1, wherein the water of the base fluid has a pH in the range of 7.5-9.

4. The method according to claim 1, wherein the base fluid comprises a water source selected from the group consisting of: freshwater; produced water; flowback water; brackish water; seawater; brine; and any combination thereof in any proportion.

5. The method according to claim 1, wherein the base fluid has less than 1 ppm free chlorine by weight of the water of the base fluid.

6. The method according to claim 1, wherein the aqueous solution of hypochlorite comprises an alkali metal hypochlorite.

7. The method according to claim 1, wherein the aqueous solution of hypochlorite is pH stabilized with an alkali metal hydroxide.

8. The method according to claim 1, wherein the aqueous solution of hypochlorite has a pH in the range of 10-14.

9. The method according to claim 1, wherein the aqueous solution of hypochlorite comprises hypochlorite in a concentration of at least 5% by weight of the water of the aqueous solution.

10. The method according to claim 1, wherein the aqueous solution of hypochlorite has a concentration of at least 50,000 ppm free chlorine by weight of the water of the aqueous solution of hypochlorite.

11. The method according to claim 1, wherein the step of continuously mixing the base fluid, the aqueous solution comprising a hypochlorite, and the pH-adjusting agent further comprises: mixing the aqueous solution of a hypochlorite in the range of 0.01%-1% by weight of the water in the base fluid.

12. The method according to claim 1, wherein the step of continuously mixing the base fluid, the aqueous solution comprising a hypochlorite, and the pH-adjusting agent is further under conditions and in proportions sufficient to obtain a stream of a treatment fluid having a free chlorine concentration of at least 10 ppm.

13. The method according to claim 1, wherein the pH-adjusting agent is in an aqueous solution prior to the step of continuously mixing.

14. The method according to claim 1, wherein the pH-adjusting agent is selected from the group consisting of: an acid, a buffering agent, and any combination thereof in any proportion.

15. The method according to claim 1, wherein the pH-adjusting agent comprises a water-soluble organic acid.

16. The method according to claim 1, wherein the pH-adjusting agent is selected from the group consisting of acetic acid, citric acid, fumaric acid, sulfamic acid, formic acid, hydroxyacetic acid, glycolic acid, and any combination thereof in any proportion.

17. The method according to claim 1, wherein the step of continuously mixing the base fluid, the aqueous solution comprising a hypochlorite, and the pH-adjusting agent is under conditions and in proportions sufficient to obtain a stream of the treatment fluid having a pH that is at least 1 pH unit lower than the pH of the water of the base fluid.

18. The method according to claim 1, wherein the step of continuously mixing the base fluid, the aqueous solution comprising a hypochlorite, and the pH-adjusting agent is under conditions and in proportions sufficient to obtain a stream of the treatment fluid has a pH in the range of 5-6.5.

19. The method according to claim 1, wherein the step of injecting further comprises: injecting the stream of the treatment fluid without holding the treatment fluid in a fluid reservoir between the step of continuously mixing and the step of injecting.

20. The method according to claim 1, wherein the step of continuously mixing comprises: co-injecting any one or two of the base fluid, the aqueous solution comprising a hypochlorite, and the pH-adjusting agent with the other one or two of the base fluid, the aqueous solution of a hypochlorite, and the pH-adjusting agent.

21. The method according to claim 1, wherein the step of continuously mixing comprises: co-injecting during the step of injecting.

22. The method according to claim 1, wherein the step of injecting further comprises: injecting the stream of the treatment fluid at a rate in the range of 5-160 barrels per minute.

23. The method according to claim 1, wherein the step of continuously mixing as a stream further comprises: mixing with a material susceptible to bacterial attack.

24. The method according to claim 1, wherein the step of continuously mixing as a stream further comprises: mixing with a material selected from the group consisting of: a polysaccharide, a sugar-headed surfactant, a friction-reducing agent, a polyvinyl alcohol, and any combination thereof in any proportion.

25. The method according to claim 1, further comprising any step selected from the group consisting of: drilling, completion, fracturing, clean up.
